(19) United States
(12) Patent Application Publication
(10) Pub. No.: US 2026/0341067 A1
(43) Pub. Date: Oct. 29, 2026

(54) VALUE EXTRACTION SYSTEM, VALUE EXTRACTION METHOD, AND PROGRAM

(71) Applicant: RAKUTEN GROUP, INC., Tokyo (JP)

(72) Inventors: Yeongnam CHAE, Setagaya-ku, Tokyo (JP); Mijung KIM, Setagaya-ku, Tokyo (JP)

(21) Appl. No.: 19/117,958

(22) PCT Filed: Mar. 31, 2023
(86) PCT No.: PCT/JP2023/013598

§ 371 Date: Apr. 2, 2025

(51) Int. Cl. G06V 30/414; G06V 30/19

(52) U.S. Cl. CPC G06V 30/414; G06V 30/19147

(57) ABSTRACT

A value extraction system, comprising at least one processor configured to: acquire an estimation image showing an estimation document which includes an estimation key and an estimation value; acquire a key specified by a user; and extract the estimation value from the estimation image based on the estimation image, the specified key, and a value extraction model which has learned a relative positional relationship between a training key and a training value included in a training document shown in a training image.

### TECHNICAL FIELD

The present disclosure relates to a value extraction system, a value extraction method, and a program.

### BACKGROUND ART

Hitherto, there has been investigated a technology of analyzing a layout of a document shown in an image. For example, in Non Patent Literature 1 to Non Patent Literature 4, there are disclosed technologies of analyzing the layout of a document based on a learning model which has learned the layouts of various types of documents and the coordinates of cells (bounding boxes) including components of the document shown in an image. In the methods of Non Patent Literature 1 to Non Patent Literature 4, the layout of the document is analyzed based on the coordinates of the individual cells in the entire image.

### CITATION LIST

### Non Patent Literature

[NPL 1] Yupan Huang, Tengchao Lv, Lei Cui, Yutong Lu, Furu Wei, “LayoutLMv3: Pre-training for Document AI with Unified Text and Image Masking,” https://arxiv.org/abs/2204.08387, ACM Multimedia 2022

[NPL 2] “Doc-former,” Internet, retrieved on Mar. 6, 2023, online, https://github.com/shabie/docformer

[NPL 3] Peizhao Li, Jiuxiang Gu, Jason Kuen, Vlad I. Morariu, Handong Zhao, Rajiv Jain, Varun Manjunatha, Hongfu Liu, “SelfDoc: Self-Supervised Document Representation Learning,” https://arxiv.org/abs/2106.03331, CVPR2021

[NPL 4] Anonymous, “ERNIE-Layout: Layout-Knowledge Enhanced Multi-modal Pre-training for Document Understanding,” https://openreview.net/pdf?id=NHECrvMz1LL

### SUMMARY OF INVENTION

### Technical Problem

For example, when a value extraction model which extracts a value corresponding to a key from a document is created by using the methods of Non Patent Literature 1 to Non Patent Literature 4, the position of the value differs depending on the document, and hence, even when a value extraction model is created by using the methods as described in Non Patent Literature 1 to Non Patent Literature 4, only the value of a specific document can be extracted. With the related-art technology, the versatility of the value extraction model is not sufficiently enhanced, and hence it has not been possible to accurately extract the value corresponding to the key.

One object of the present disclosure is to accurately extract a value corresponding to a key.

### Solution to Problem

According to one embodiment of the present disclosure, there is provided a value extraction system including: an estimation image acquisition module configured to acquire an estimation image showing an estimation document which includes an estimation key and an estimation value; a specified key acquisition module configured to acquire a specified key specified by a user; and an extraction module configured to extract the estimation value from the estimation image based on the estimation image, the specified key, and a value extraction model which has learned a relative positional relationship between a training key and a training value included in a training document shown in a training image.

### Advantageous Effects of Invention

According to the present disclosure, it is possible to accurately extract the value corresponding to the key.

### BRIEF DESCRIPTION OF DRAWINGS

FIG. 1 is a diagram for illustrating an example of an overall configuration of a value extraction system.

FIG. 2 is a diagram for illustrating an example of how a user photographs an estimation document.

FIG. 3 is a diagram for illustrating an example of an estimation image on which character recognition has been executed.

FIG. 4 is a diagram for illustrating an example of a relationship between an input and an output of a trained value extraction model.

FIG. 5 is a diagram for illustrating an example of functions implemented by the value extraction system.

FIG. 6 is a table for showing an example of a training database.

FIG. 7 is a flowchart for illustrating an example of processing executed by the value extraction system.

FIG. 8 is a diagram for illustrating an example of functions implemented by a value extraction system of modification examples.

FIG. 9 is a table for showing an example of a training database in Modification Example 1.

### DESCRIPTION OF EMBODIMENTS

### 1. Overall Configuration of Value Extraction System

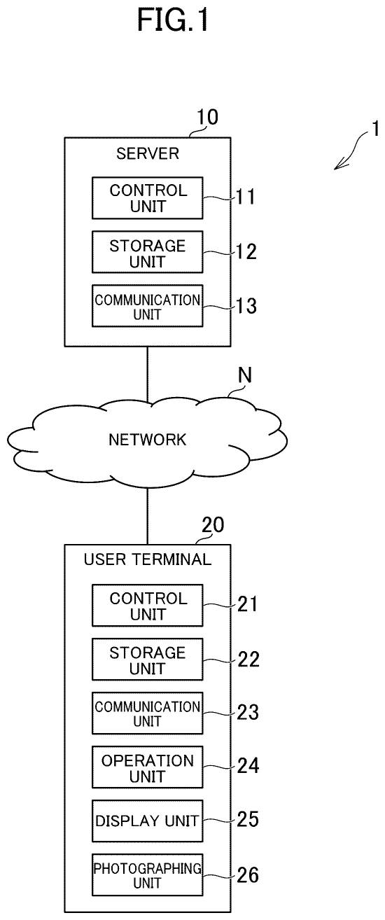

Description is now given of an example of an embodiment of a value extraction system according to the present disclosure. FIG. 1 is a diagram for illustrating an example of an overall configuration of the value extraction system. For example, a value extraction system 1 includes a server 10 and a user terminal 20. The server 10 and the user terminal 20 are each connectable to a network N, such as the Internet or a LAN.

The server 10 is a server computer. A control unit 11 includes at least one processor. A storage unit 12 includes a volatile memory such as a RAM, and a nonvolatile memory such as a flash memory. A communication unit 13 includes at least one of a communication interface for wired communication or a communication interface for wireless communication.

The user terminal 20 is a computer of a user. For example, the user terminal 20 is a personal computer, a tablet terminal, a smartphone, or a wearable terminal. The physical configurations of a control unit 21, a storage unit 22, and a communication unit 23 are the same as those of the control unit 11, the storage unit 12, and the communication unit 13, respectively. An operation unit 24 is an input device such as a touch panel or a mouse. A display unit 25 is a liquid crystal display or an organic EL display. A photographing unit 26 includes at least one camera.

The programs stored in the storage units 12 and 22 may be supplied via the network N. Further, each of the server 10 and the user terminal 20 may include at least one of a reading unit (for example, a memory card slot) for reading a computer-readable information storage medium or an input/output unit (for example, a USB port) for inputting/outputting data to and from external devices. For example, a program stored in an information storage medium may be supplied via at least one of the reading unit or the input/output unit.

Moreover, it is only required for the value extraction system 1 to include at least one computer, and is not limited to the example of FIG. 1. For example, the value extraction system 1 may not include the user terminal 20, and may include only the server 10. In this case, the user terminal 20 exists outside the value extraction system 1. For example, the value extraction system 1 may include another computer other than the server 10, and processing described in this embodiment may be executed by this another computer. For example, the another computer is a personal computer, a tablet terminal, or a smartphone.

### 2. Overview of Value Extraction System

In this embodiment, a case in which the value extraction system 1 executes both learning by a value extraction model and estimation based on the trained value extraction model is given as an example. The value extraction system 1 may execute only one of learning and estimation. That is, in this embodiment, a case in which the value extraction system 1 has a learning function and an estimation function is given as an example, but the value extraction system 1 may have only one of the learning function and the estimation function.

The value extraction model is a model which extracts a value corresponding to a key from an image in which a document including a key and a value is shown. The value extraction model is a model which uses a machine learning technology. In this embodiment, a case in which the value extraction model is a Vision Transformer-based model is given as an example, but the machine learning method itself can use various methods used in the field of image processing. For example, the value extraction model may be a model which uses a neural network or a support vector machine.

The key is information indicating the meaning of a value. The key can also be referred to as an attribute, a description, or a heading of a value. The value is information indicating a specific value of the key. The value can also be referred to as the details or content of the key. When the key is referred to as an attribute, the value corresponds to the attribute value. In this embodiment, a case in which the key and the value are each a character string (text) is given as an example, but the key and the value may each be in any format, and are not limited to a character string. For example, at least one of the key or the value may be a symbol string which is not classified as a character string, a barcode, a two-dimensional code, or an icon. The format of the key and the format of the value may be different, such as a case in which the key is a character string and the value is a two-dimensional code.

A document is a piece of written communication that includes information that can be viewed and understood by a human. For example, a document is a sheet of paper or a card on which characters are formed. In this embodiment, a case in which the document is a receipt is given as an example, but the document may be any type of written communication, and the document is not limited to the receipt. For example, the document may be an invoice, an estimate, an application, an official written communication, an internal written communication, a flyer, an academic paper, a magazine, a newspaper, a reference book, or a piece of written communication that identifies a person. The value extraction model can extract values from images showing any document. The value extraction model may be trained by using only one type of document, or trained by using a plurality of types of documents.

The document includes at least one key and at least one value. In this embodiment, a case in which the document includes one key and one value is given as an example, but the document may include one key and a plurality of values. The document may include a plurality of keys and one value. The document may include a plurality of keys and a plurality of values. That is, the key and the value may have a one-to-one, one-to-many, many-to-one, or many-to-many relationship. The document may include other information other than keys and values.

The image that is to be learned by the value extraction model is hereinafter referred to as “training image.” The document shown in the training image is referred to as “training document.” The key and the value included in the training document are referred to as “training key” and “training value,” respectively. The image to be estimated by the trained value extraction model is referred to as “estimation image.” The document shown in the estimation image is referred to as “estimation document.” The key and the value included in the estimation document are referred to as “estimation key” and “estimation value,” respectively. In this embodiment, description is given of an example in which the user has the estimation document. For example, the user photographs the estimation document by using the photographing unit 26.

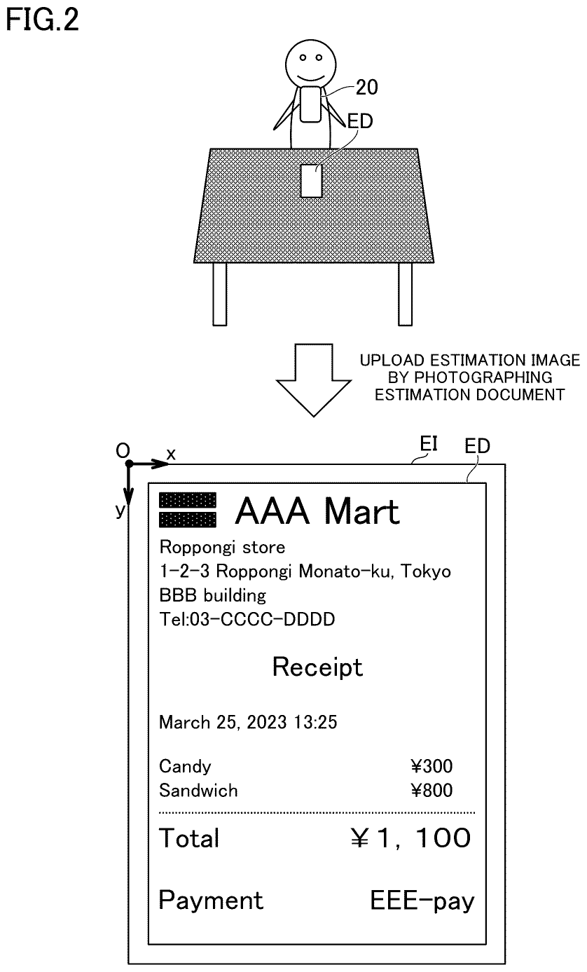

FIG. 2 is a diagram for illustrating an example of how a user photographs an estimation document. For example, when a user photographs an estimation document ED by using the photographing unit 26, the user terminal 20 generates an estimation image EI in which the estimation document ED is shown. In the example of FIG. 2, it is assumed that an x-axis and a y-axis are set with an upper left of the estimation image EI as an origin O. Positions in the estimation image EI are indicated by two-dimensional coordinates including an x-coordinate and a y-coordinate. Positions in the estimation image EI can be expressed through use of any-coordinate system, and are not limited to the example illustrated in FIG. 2. For example, positions in the estimation image EI may be expressed through use of a coordinate system in which the center of the estimation image EI is the origin O, or expressed through use of a polar coordinate system.

In this embodiment, a case in which the character string “Payment” printed on the estimation document ED corresponds to the estimation key and the character string indicating the payment method (“EEE-pay”in the example of FIG. 2) printed on the estimation document ED corresponds to the estimation value is given as an example. It suffices that the estimation key and the estimation value are pieces of information that are paired with each other, and hence the estimation key and the estimation value are not limited to the example of this embodiment. For example, the character string “Total” printed on the estimation document ED may correspond to the estimation key, and the total amount printed on the estimation document ED may correspond to the estimation value. The character string “Tel” printed on the estimation document ED may correspond to the estimation key, and the telephone number printed on the estimation document ED may correspond to the estimation value.

For example, the user specifies the same key as the estimation key from the operation unit 24. The key specified by the user is hereinafter referred to as “specified key.” The user specifies the specified key by inputting a given character string or by selecting the specified key from a plurality of candidates. The user terminal 20 transmits the specified key and the estimation image EI to the server 10. The server 10 receives the specified key and the estimation image EI from the user terminal 20, and executes character recognition on the estimation image EI.

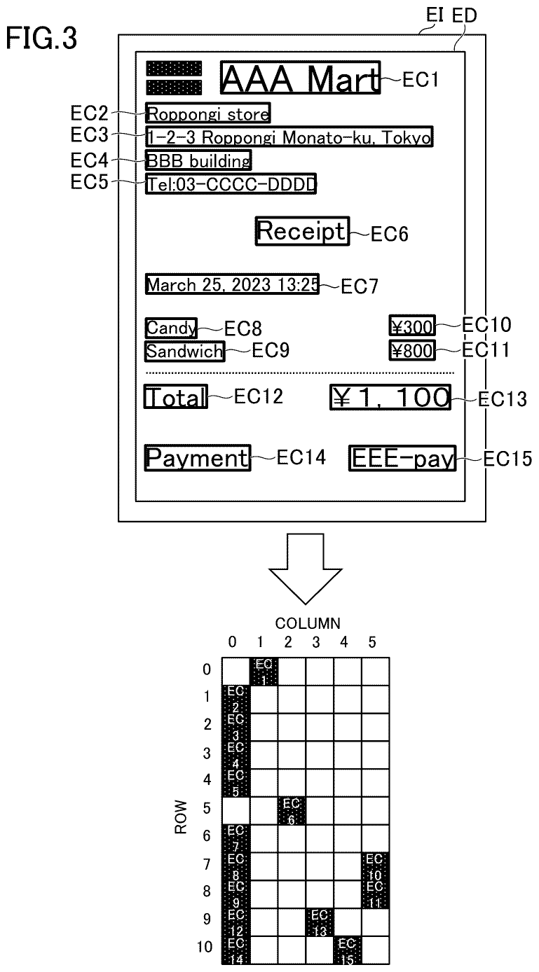

FIG. 3 is a diagram for illustrating an example of an estimation image EI on which character recognition has been executed. For example, the server 10 detects estimation cells EC1 to EC15 from in the estimation image EI by using a publicly-known character recognition tool. When the estimation cells EC1 to EC15 are not distinguished from one another, the estimation cells EC1 to EC15 are hereinafter simply referred to as “estimation cells EC.” The estimation cells EC may have any shape, and are not limited to the rectangle shape illustrated in FIG. 3. For example, the estimation cells EC may be squares, rounded rectangles, polygons other than a rectangle, or ellipses.

Each estimation cell EC is an area which includes at least one character. The estimation cells EC are sometimes referred to as “bounding boxes.” In this embodiment, the estimation cells EC are detected by using a character recognition tool, and thus each estimation cell EC includes at least one character. An estimation cell EC may be detected for each character, but in this embodiment, a plurality of consecutive characters are detected as one estimation cell EC. For example, when a space arranged between characters is small, one estimation cell EC including a plurality of words separated by spaces may be detected.

In this embodiment, the server 10 identifies the positions of the estimation cells EC by using a matrix instead of coordinates. For example, the server 10 classifies the estimation cells EC having coordinates that are close to each other into the same row or the same column. As a result, a slight difference in the coordinates among estimation cells EC that are originally in the same row or the same column can be absorbed. In the example of FIG. 3, the estimation cell EC1 is in the 0th row and 1st column. The estimation cell EC2 is in the 1st row and 0th column. The estimation cell EC3 is in the 2nd row and 0th column. The positions of the estimation cells EC4 to C15 are similarly identified by using the matrix.

For example, the server 10 acquires estimation cell information on each of the plurality of estimation cells EC. The estimation cell information may be any information relating to the estimation cell EC. For example, the estimation cell information includes at least one of a matrix position of the estimation cell EC, a character string included in the estimation cell EC, coordinates of the estimation cell EC, a width of the estimation cell EC, or image data in the estimation cell EC. The server 10 inputs the estimation cell information on each of the plurality of estimation cells EC and the specified key to the trained value extraction model.

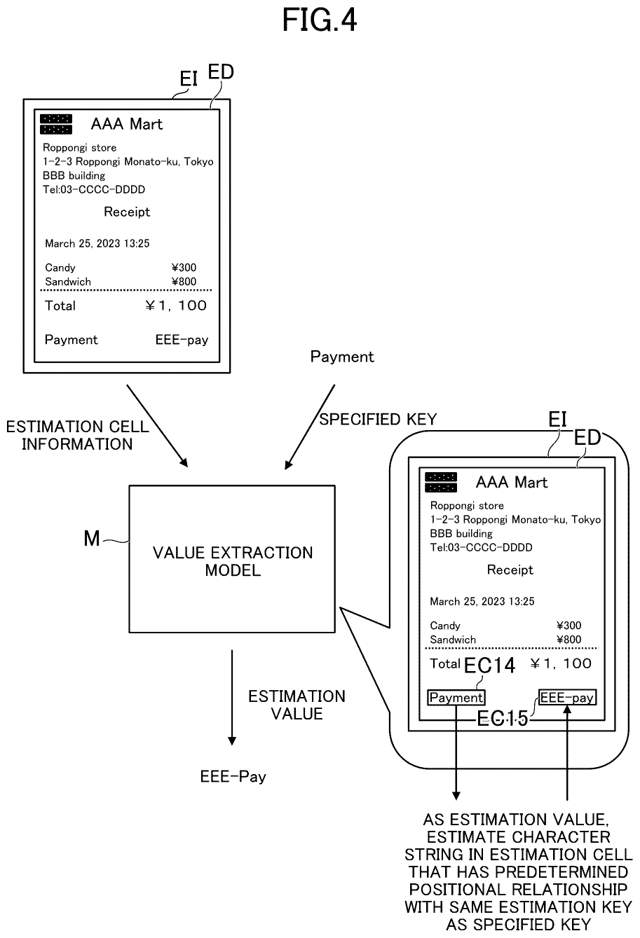

FIG. 4 is a diagram for illustrating an example of a relationship between an input and an output of a trained value extraction model. For example, the value extraction model M identifies, when the estimation cell information on each of the plurality of estimation cells EC is input, the estimation cells EC having an estimation key which is a character string that matches the specified key included in the estimation cell information from among the plurality of estimation cells EC. In the example of FIG. 4, the value extraction model M identifies that the estimation key is included in the estimation cell EC 14. The value extraction model M estimates that the estimation value is included in the estimation cell EC15, which has a predetermined positional relationship with the estimation cell EC14.

For example, when the value extraction model M has learned that there is a training value in the same row as that of the training key and is to the right of the training key, the value extraction model M estimates that an estimation value is included in the estimation cell EC15 that is in the same row as that of the estimation cell EC14 and is to the right of the estimation cell EC 14. Thus, the value extraction model M outputs the character string “EEE-Pay” included in the estimation cell EC15 as the estimation value. The server 10 transmits the estimation value output from the value extraction model M to the user terminal 20.

In this embodiment, the value extraction model M has learned various training documents and the relative positional relationships between various training keys and training values. For example, the value extraction model M has learned the relative positional relationships between the training keys and the training values included in various training documents, such as not only receipts but also invoices and estimates. Thus, when the user specifies a specified key, because the relative positional relationships between various training keys and training values have been learned, the value extraction model M can estimate the position of the estimation value corresponding to the same estimation key as the specified key.

As described above, the value extraction model M has learned the relative positional relationship between the training key and the training value. The value extraction system 1 can accurately extract the estimation value corresponding to the estimation key by extracting the estimation value from the estimation image EI based on the estimation image EI, the specified key, and the trained value extraction model M. Details of this embodiment are now described.

### 3. Functions Implemented by Value Extraction System

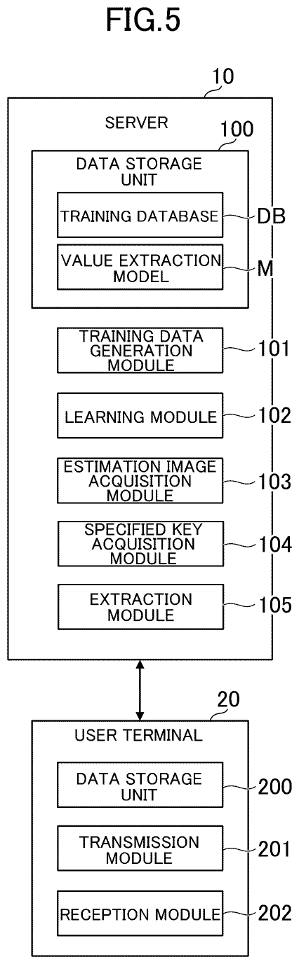

FIG. 5 is a diagram for illustrating an example of functions implemented by the value extraction system 1.

### [3-1. Functions Implemented by Server]

For example, the server 10 includes a data storage unit 100, a training data generation module 101, a learning module 102, an estimation image acquisition module 103, a specified key acquisition module 104, and an extraction module 105. The data storage unit 100 is implemented by the storage unit 12 illustrated in FIG. 1. The training data generation module 101, the learning module 102, the estimation image acquisition module 103, the specified key acquisition module 104, and the extraction module 105 are implemented by the control unit 11 illustrated in FIG. 1.

### [Data Storage Unit]

The data storage unit 100 stores data required for at least one of learning by the value extraction model M or estimation based on the trained value extraction model M. For example, the data storage unit 100 stores a training database DB in which training data for training the value extraction model M is stored.

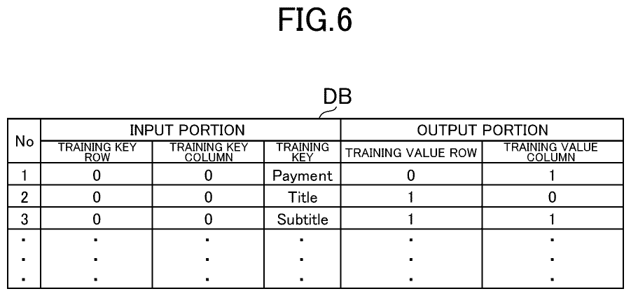

FIG. 6 is a table for showing an example of the training database DB. In FIG. 6, “No” is identification information on the training data. In the example of FIG. 6, three pieces of training data are shown. For example, the training data includes an input portion which is input to the value extraction model M during learning, and an output portion which is to be output from the value extraction model M during learning. The format of the input portion of the training data is the same as the format of the input data input to the value extraction model M during estimation. The format of the output portion of the training data is the same as the format of the output data output from the value extraction model M during estimation.

The input portion of the training data includes information relating to the position of the training key. The output portion of the training data includes information relating to the position of the training value. The training data includes those input portions and output portions, and thus the relative positional relationship between the training key and the training value is indicated in the training data. In this embodiment, description is given of a case in which the position is expressed by a matrix, but the position may be expressed in another format such as coordinates or a vector.

For example, the input portion of the training data includes training cell information relating to a training cell extracted from the training image. A training cell is different from an estimation cell in that the training cell is extracted from a training image, but is the same as an estimation cell in other respects. Thus, the word “estimation” when used in the description relating to an estimation cell may be read as “training” when used in the description relating to a training cell. For example, the training cell information includes at least one of a matrix position of the training cell, a character string included in the training cell, coordinates of the training cell, a width of the training cell, or image data in the training cell.

A training cell including a training key is hereinafter referred to as “training key cell.” Other training cells including a character string other than a training key are also extracted from the training image, and hence when other training cells and the training key cell are not distinguished from one another, other training cells and the training key cell are hereinafter simply referred to as “training cells.” In the example of FIG. 6, a case in which the input portion of training data includes only a training key cell is shown, but the input portion of training data may include training cell information on other training cells.

For example, the output portion of the training data includes training cell information relating to the training value extracted from the training image. A training cell including a training value is hereinafter referred to as “training value cell.” Other training cells including a character string other than a training value are also extracted from the training image, and hence when other training cells and the training value cell are not distinguished from one another, other training cells and the training value cell are hereinafter simply referred to as “training cells.” In the example of FIG. 6, a case in which the output portion of training data includes only a training value cell is shown, but the output portion of training data may include other training cells.

In this embodiment, the row and column indicating the position of the training value cell are based on the position of the training key cell. For example, the row and column of the training value cell obtained when the row and column of the training key cell are (0, 0) are shown in the output portion of the training data. In the example of FIG. 6, the input portion of the first piece of training data includes the row and column (0, 0) indicating the position of the training key “Payment.” The training value of the first piece of training data is in the Same row as that of the training key “Payment” and one column away to the right, and thus the output portion of the first piece of training data includes the row and column (0, 1) indicating the position of that training value.

The training data may indicate an absolute matrix position in the training image in place of a matrix based on the position of the training key cell. It suffices that the training data shows a relative positional relationship between the training key cell and the training value cell. Further, when the position in the training image is expressed by coordinates instead of a matrix, the training data may include coordinates indicating the position of the training key cell and coordinates indicating the position of the training value. When a training cell is not used, the training data may include coordinates or a matrix indicating the position of the training key and coordinates or a matrix indicating the position of the training value.

For example, the data storage unit 100 stores the value extraction model M before learning. The value extraction model M includes programs and parameters. The parameters are adjusted by learning. The value extraction model M before learning is a value extraction model M having initial values for the parameters. As described above, in this embodiment, a case in which the value extraction model M is a Vision Transformer-based model is given as an example. Vision Transformer is a method which applies Transformer, which is mainly used in natural language processing, to image processing.

For example, transformer analyzes connections in input data in which the components of a document are arranged in chronological order. For example, Vision Transformer divides an input image which has been input to Vision Transformer into a plurality of patches, and acquires input data in which w a plurality of patches are arranged. Vision Transformer is a method which uses context analysis by Transformer to analyze connections between patches. Vision Transformer converts each of the patches included in the input data into a vector, and analyzes the vectors. The value extraction model M in this embodiment uses this Vision Transformer architecture.

The data stored in the data storage unit 100 is not limited to the above-mentioned example. It suffices that the data storage unit 100 stores the data required for at least one of learning by the value extraction model M or estimation based on the trained value extraction model M, and the data storage unit 100 can store any data. For example, the data storage unit 100 may store a program for executing the learning by the value extraction model M, an estimation image database in which estimation images EI are stored, a training image database in which training images are stored, and a character recognition tool.

### [Training Data Generation Module]

The training data generation module 101 generates training data. In this embodiment, description is given of a case in which the training data generation module 101 generates the training data from a training image, but the training data may be manually generated by a person who creates the value extraction model M. For example, the creator visually checks the training image and annotates the position of the training key and the position of the training value. The training data generation module 101 may generate the training data based on the result of annotation by the creator.

For example, the training data generation module 101 generates, based on character recognition on the training image, training data including training key cell information relating to the position of the training key cell which includes the training key, and training value cell information relating to the position of the training value cell which includes the training value. The training data generation module 101 executes on the training image the same character recognition as that executed on the estimation image EI described with reference to FIG. 3. The training data generation module 101 identifies a training key cell and a training value cell from among a plurality of training cells extracted from a training image. It is assumed that the training key and the training value are specified in advance by the creator.

For example, the training data generation module 101 identifies, from among the plurality of training cells, a training cell which includes a character string matching the training key as the training key cell. The training data generation module 101 identifies, from among the plurality of training cells, a training cell which includes a character string matching the training value as the training value cell. The character string match may be a complete match or a partial match. The creator may visually check the training cells and annotate the training key cell and the training value cell. In this case, the training data generation module 101 identifies the training key cell and the training value cell based on the result of annotation by the creator.

For example, the training data generation module 101 calculates the matrix position of the training value cell based on the matrix position of the training key cell. The training data generation module 101 generates, as the input portion of the training data, a pair of (0, 0) indicating the matrix position of the training key cell and a character string indicating the training key. The training data generation module 101 generates, as the output portion of the training data, the matrix position of the training value cell, which is based on the matrix position of the training value cell training key cell. The training data generation module 101 generates the training data by combining the generated input portion and output portion. The training data generation module 101 generates pieces of training data one after another by executing the same processing on other training images.

### [Learning Module]

The learning module 102 executes learning by the value extraction model M based on the training data. For the learning itself, various methods used in machine learning methods can be used. For example, the learning module 102 may execute learning by the value extraction model M based on error backpropagation or gradient descent. The learning module 102 adjusts the parameters of the value extraction model M so that when the input portion of the training data is input, the output portion of the training data is output. The learning module 102 executes learning by the value extraction model M until a loss calculated based on a loss function becomes sufficiently small. When the learning by the value extraction model M is complete, the learning module 102 records the trained value extraction model M in the data storage unit 100.

### [Estimation Image Acquisition Module]

The estimation image acquisition module 103 acquires an estimation image EI in which an estimation document ED including an estimation key and an estimation value is shown. In this embodiment, the user terminal 20 transmits the estimation image EI to the server 10, and thus the estimation image acquisition module 103 acquires the estimation image EI from the user terminal 20. The estimation image EI may be recorded in advance in the data storage unit 100 or an external storage medium. In this case, the estimation image acquisition module 103 may acquire the estimation image EI from the data storage unit 100 or the external storage medium.

### [Specified Key Acquisition Module]

The specified key acquisition module 104 acquires the specified key specified by the user. In this embodiment, the user terminal 20 transmits the specified key to the server 10, and thus the specified key acquisition module 104 acquires the specified key from the user terminal 20. The specified key may be recorded in advance in the data storage unit 100 or an external storage medium. In this case, the specified key acquisition module 104 may acquire the specified key from the data storage unit 100 or the external storage medium.

### [Extraction Module]

The extraction module 105 extracts an estimation value from the estimation image EI based on the estimation image EI, the specified key, and the value extraction model M which has learned the relative positional relationship between the training key and the training value included in the training document shown in the training image. The extraction module 105 acquires the input data to be input to the value extraction model M based on the estimation image EI and the specified key. The extraction module 105 inputs the input data to the value extraction model M. The value extraction model M calculates a feature amount of the input data based on parameters adjusted by learning. The value extraction model M outputs an estimation result of an estimation value based on the feature amount of the input data. The extraction module 105 extracts the estimation value from the estimation image EI by acquiring the estimation value output from the value extraction model M.

In this embodiment, the value extraction model M has learned the relative positional relationship between a row and a column of the training key in the training image and a row and a column of the training value in the training image. For example, the value extraction model M has learned the row and column positions of the training value based on the row and column positions of the training key. The value extraction model M may learn the row and column positions of the training key and the row and column positions of the training value based on an origin of the training image, instead of based on the row and column positions of the training key.

For example, the extraction module 105 acquires the row and the column of the specified key based on the execution result of character recognition on the estimation image EI. In this embodiment, a case in which the extraction module 105 executes optical character recognition on the estimation image EI is given as an example, but the extraction module 105 may execute character recognition on the estimation image EI based on a method other than optical character recognition. For example, the extraction module 105 may execute character recognition based on template matching in which a comparison is made with a template image, a method which analyzes a distribution of pixel values as a histogram, a machine learning method such as a neural network, or another method. Similarly, the character recognition by the training data generation module 101 may also be various methods, including optical character recognition.

For example, the extraction module 105 extracts estimation cells, which are cells including at least one character, from the estimation image EI. The extraction module 105 acquires the row and the column of each of a plurality of estimation cells so that, based on the coordinates of each of the plurality of estimation cells, the estimation cells having x-coordinates close to each other belong to the same column and the estimation cells having y-coordinates close to each other belong to the same row. Acquiring the row and the column means identifying the position of the row and the position of the column. For example, when a row number and a column number are assigned sequentially from the upper left of the estimation image EI, the extraction module 105 acquires the row number and the column number of each of the plurality of estimation cells.

For example, the extraction module 105 extracts the estimation value based on the row and the column of the specified key and the value extraction model M. In this embodiment, a case in which the processing of identifying the row and the column of the specified key is executed internally in the value extraction model M is given as an example, but the processing of identifying the row and the column of the specified key may be executed outside the value extraction model M. For example, the extraction module 105 may identify the row and the column of the specified key, and then input the identified row and column of the specified key to the value extraction model M. That is, the extraction module 105 may identify the row and the column of the specified key as preprocessing of the estimation by the value extraction model M.

For example, the extraction module 105 inputs each piece of estimation cell information extracted from the estimation image EI and the specified key to the value extraction model M. The value extraction model M identifies, from among the plurality of pieces of estimation cell information, the estimation cell information including a character string that is the same as or similar to the specified key. The value extraction model M identifies the row and the column indicated by the identified estimation cell information as the row and the column of the specified key. The value extraction model M estimates and outputs the row and the column of the estimation key based on the row and the column of the identified specified key. The extraction module 105 extracts the estimation value from the estimation image EI by acquiring the row and the column of the estimation key output from the value extraction model M.

In this embodiment, the value extraction model M has learned a relative positional relationship between training key cell information relating to the position of the training key cell which includes the training key and training value cell information relating to the position of the training value cell which includes the training value. The extraction module 105 acquires the estimation key cell information relating to the position of the estimation key cell including the estimation key based on character recognition on the estimation image EI. The extraction module 105 extracts the estimation value based on the estimation key cell information and the value extraction model M.

In this embodiment, the extraction module 105 extracts the estimation value based on the value extraction model M trained by the learning module 102. The learning by the value extraction model M may be executed by another computer other than the server 10. In this case, the data storage unit 100 stores a value extraction model M that has been trained by the another computer. The extraction module 105 may extract the estimation value based on the value extraction model M trained by the another computer.

In this embodiment, the value extraction model M has learned the relative positional relationship between one training key and one training value corresponding to the one training key. That is, the training key and the training value have a one-to-one correspondence. The estimation key and the estimation value also have a one-to-one correspondence. The extraction module 105 extracts one estimation value corresponding to one specified key from the estimation image EI.

The processing executed by the extraction module 105 is not limited to the above-mentioned example. For example, the format of the input data input to the value extraction model M and the format of the output data output from the value extraction model M may be any format determined in advance, and are not limited to the example of this embodiment. The extraction module 105 may input a pair of an estimation image EI and a specified key as input data to the value extraction model M. In this case, the value extraction model M calculates the feature amount of the estimation image EI by, for example, convolving the estimation image EI, and executes estimation corresponding to the feature amount and the specified key. The value extraction model M may output a character string of the estimation value instead of outputting the estimation cell information relating to the position of the estimation value cell.

### [3-2. Functions Implemented by User Terminal]

A data storage unit 200 is mainly implemented by the storage unit 22. A transmission module 201 and a reception module 202 are mainly implemented by the control unit 21.

### [Data Storage Unit]

The data storage unit 200 stores data required for acquiring the estimation image EI. For example, the data storage unit 200 stores the estimation image EI generated by the photographing unit 26.

### [Transmission Module]

The transmission module 201 transmits various types of data to the server 10. For example, the transmission module 201 transmits the estimation image EI to the server 10.

### [Reception Module]

The reception module 202 receives various types of data from the server 10. For example, the reception module 202 receives the estimation value estimated by the value extraction model M from the server 10. The user terminal 20 displays the estimation value on the display unit 25.

### 4. Processing Executed by Value Extraction System

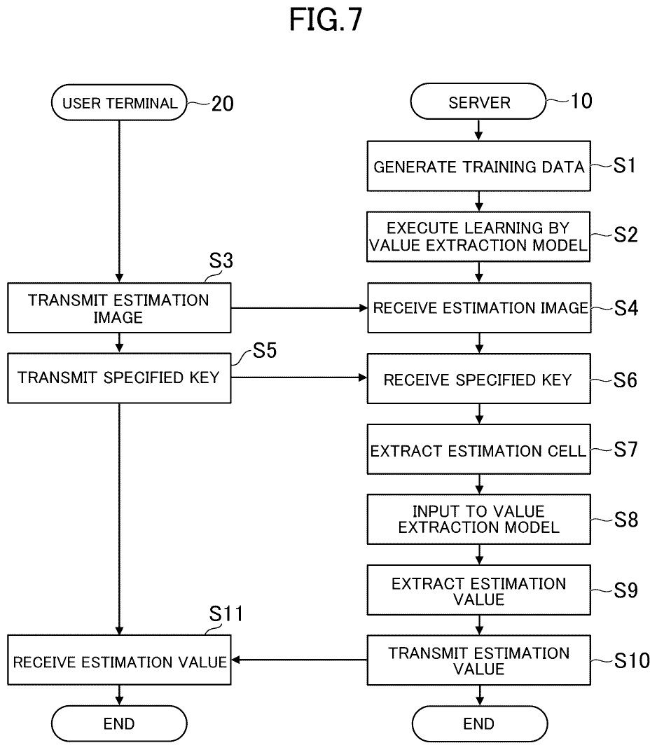

FIG. 7 is a flowchart for illustrating an example of processing executed by the value extraction system 1. The processing of FIG. 7 is executed by the control units 11 and 21 executing programs stored in the storage units 12 and 22, respectively. As illustrated in FIG. 7, the server 10 executes character recognition on the training image, extracts the training key cell and the training value cell, and generates training data which includes the training key cell information and the training value cell information (Step S1). The server 10 executes learning by the value extraction model M based on the training data stored in the training database DB (Step S2).

When the user photographs an estimation document ED by using the photographing unit 26, the user terminal 20 generates an estimation image EI, and transmits the generated estimation image EI to the server 10 (Step S3). The server 10 receives the estimation image EI from the user terminal 20 (Step S4). The user terminal 20 receives the specification of the specified key by the user, and transmits the specified key to the server 10 (Step S5). The user terminal 20 receives the specified key from the user terminal 20 (Step S6). The user terminal 20 may transmit the estimation document ED and the specified key to the server 10 all at once.

The server 10 executes character recognition on the estimation image EI, and extracts the estimation cells EC (Step S7). In Step S7, the server 10 acquires the portions of the cell information on the estimation cells EC other than the row number and the column number. The server 10 acquires the cell information on each of the plurality of estimation cells EC by assigning, based on the y-coordinate of each of the plurality of estimation cells EC, the same row number to the estimation cells EC belonging to the same row, and based on the x-coordinate of each of the plurality of estimation cells EC, the same column number to the estimation cells EC belonging to the same column.

The server 10 inputs the estimation cell information on each of the plurality of estimation cells EC and the specified key to the value extraction model M (Step S8). The value extraction model M calculates the feature amount of the input data input to the value extraction model M, and outputs an estimation result corresponding to the feature amount. The server 10 extracts the estimation value from the estimation image EI based on the output from the value extraction model M (Step S9). The server 10 transmits the estimation value to the user terminal 20 (Step S10). The user terminal 20 receives the estimation value from the server 10 (Step S11), and this processing is finished.

### 5. Summary of Embodiment

The value extraction system 1 of this embodiment extracts the estimation value from the estimation image EI based on the estimation image EI, the specified key, and the trained value extraction model M. As a result, the estimation value corresponding to the estimation key can be extracted with high accuracy. For example, like in Non Patent Literature 1 to Non Patent Literature 4, when a model learns the position of an estimation value for the entire image, the model can only handle documents having a specific layout. However, when the relative positional relationship between the estimation key and the estimation value is similar to the relative positional relationship between the training key and the training value, the value extraction system 1 can extract the estimation value even for an unknown estimation document ED. Thus, the value extraction system 1 can handle various types of estimation values of various types of estimation document ED, and therefore the versatility of the value extraction model M can be enhanced.

Further, the value extraction system 1 acquires the row and the column of the specified key based on the execution result of character recognition on the estimation image EI, and extracts the estimated value based on the row and the column of the specified key and the value extraction model M. As a result, the value extraction system 1 can extract the estimation value after having absorbed a slight deviation in the coordinates indicating the position of the estimation cell EC, and therefore can further improve the extraction accuracy of the estimation value.

Further, the value extraction system 1 acquires, based on character recognition on the estimation image EI, estimation key cell information relating to the position of the estimation key cell which includes the estimation key. The value extraction system 1 extracts the estimation value based on the estimation key cell information and the value extraction model M. As a result, the value extraction system 1 enables the value extraction model M easily identify a tendency of the estimation image EI by using character recognition, and thus the extraction accuracy of the estimation value can be further improved.

Further, the value extraction system 1 generates training data which includes training key cell information and training value cell information based on character recognition on the training image. The value extraction system 1 executes learning by the value extraction model M based on the training data. The value extraction system 1 extracts the estimation value based on the trained value extraction model M. As a result, the value extraction system 1 can automate the processing of generating training data, and thus the amount of work and effort required by the creator of the value extraction model M to prepare the training data can be reduced.

Further, the value extraction model M has learned the relative positional relationship between one training key and one training value corresponding to the one training key. The value extraction system 1 extracts one estimation value corresponding to one specified key from the estimation image EI. As a result, the value extraction system 1 can extract the estimation value from an estimation document ED in which the estimation key and the estimation value have a one-to-one correspondence.

### 6. MODIFICATION EXAMPLES

The present disclosure is not limited to the embodiment described above, and can be modified suitably without departing from the spirit of the present disclosure.

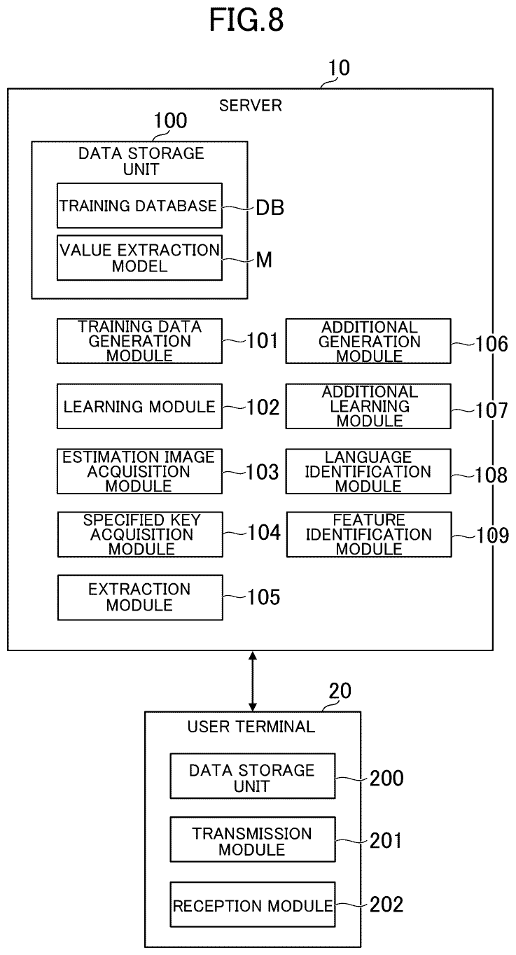

FIG. 8 is a diagram for illustrating an example of functions implemented by a value extraction system 1 of modification examples. For example, the server 10 in the modification examples includes an additional generation module 106, an additional learning module 107, a language identification module 108, and a feature identification module 109. The additional generation module 106, the additional learning module 107, the language identification module 108, and the feature identification module 109 are implemented by the control unit 11.

### 6-1. Modification Example 1

For example, in the embodiment, a case in which the positions of training values based on the training key are learned by the value extraction model M is given as an example. The training values are not limited to positions in one direction with respect to the training key. For this reason, the value extraction model M may learn whether or not a training value exists in each of a plurality of directions based on the position of the training key in the training image.

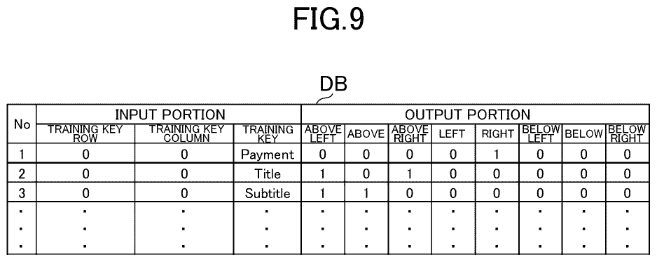

FIG. 9 is a table for showing an example of a training database DB in Modification Example 1. For example, the training data shows values indicating whether or not a training value exists in each of eight directions (above left, above, above right, left, right, below left, below, and below right) based on the training key. In the example of FIG. 9, the output portion of the training data includes eight values. A value of “0” means that no training value exists. A value of “1” means that a training value exists.

For example, in the first piece of training data of FIG. 9, the value corresponding to the right of the training key is “1”, indicating that a training value exists to the right of the training key. In the second piece of training data, the value corresponding to the above left of the training key is “1” and the value corresponding to the above right of the training key is “1”, indicating that a training value exists at the above left and above right of the training key. When two training values exist for one training key, like in the case of the second piece of training data, the value in each of a plurality of directions may be “1”.

The learning module 102 in Modification Example 1 executes learning by the value extraction model M so that when the input portion of the training data of FIG. 9 is input to the value extraction model M, the value extraction model M outputs the output portion of the training data of FIG. 9. The value extraction model M in Modification Example 1 outputs values indicating whether a training value exists in each of a plurality of directions. In the example of FIG. 9, the value extraction model M outputs eight values. For example, the value extraction model M outputs eight values in a vector format, an array format, or another format.

The extraction module 105 in Modification Example 1 extracts estimation values by causing the value extraction model M to determine whether or not an estimation value exists in each of a plurality of directions based on the position of the specified key in the estimation image EI. For example, the extraction module 105 inputs the same estimation cell information and specified key as in the embodiment to the value extraction model M. The value extraction model M in Modification Example 1 has learned whether or not a training value exists in each of a plurality of directions with respect to the training key, and thus estimates whether or not the estimation value exists in each of the plurality of directions based on the feature amount of the estimation cell information.

For example, the value extraction model M outputs a value indicating whether or not an estimation value exists in each of the plurality of directions. In the example of the training data of FIG. 9, the value extraction model M outputs a value indicating whether or not the estimation value exists in each of eight directions based on the estimation key. The extraction module 105 acquires the eight values output from the value extraction model M. The extraction module 105 acquires, as the estimation key, the character string included in the estimation cells of the directions indicating that an estimation value exists among the eight values.

The value extraction system 1 of Modification Example 1 extracts estimation values by causing the value extraction model M to determine whether or not an estimation value exists in each of a plurality of directions based on the position of the specified key in the estimation image EI. As a result, the value extraction system 1 can extract the estimation value even when there are a plurality of directions in which the estimation value exists for the estimation key.

### 6-2. Modification Example 2

For example, in Modification Example 1, there may be a case in which the value extraction model M estimates that an estimation value exists in each of a plurality of directions for the estimation key. In this case, when only one estimation value exists for one estimation key, only the estimation result of one direction is correct, and the estimation results of the remaining directions are incorrect. When the directions in which the estimation value is likely to exist for the estimation key are identified in advance, a priority order may be determined for each of the plurality of directions.

The data storage unit 100 in Modification Example 2 stores data indicating a relationship between each of the plurality of directions and the priority order. In the example of the training data of FIG. 9, a priority order is determined for each of eight directions. In this example, the right direction has the highest priority order, the priority order of the above right direction and the below right direction is the same and is the second highest, and the priority order of the other directions is the lowest. When there are a plurality of directions in which it is determined that the estimation value exists, the extraction module 105 extracts the estimation value based on the priority order of each of the plurality of directions.

For example, the extraction module 105 extracts, as the estimation value, the character string in the direction having the highest priority order among the plurality of directions in which it is determined that the estimation value exists. The extraction module 105 may select a predetermined number of directions in descending order of the priority order from among the plurality of directions in which it is determined that the estimation value exists, and extract the character strings in the selected directions as the estimation value. The extraction module 105 may select all of the directions in which the priority order is equal to or more than a threshold value from among the plurality of directions in which it is determined that the estimation value exists, and extract the character strings in the selected directions as the estimation value.

When there are a plurality of directions in which it is determined that the estimation value exists, the value extraction system 1 of Modification Example 2 extracts the estimation value based on the priority order of each of the plurality of directions. As a result, the value extraction system 1 can improve the extraction accuracy of the estimation value.

### 6-3. Modification Example 3

For example, in the embodiment, a case in which the estimation document ED and the training document are both receipts, and hence are the same type as each other is given as an example. However, the estimation document ED and the training document may be different types from each other. For example, the estimation document ED may be a receipt, and the training document may be an estimate. As long as the tendency between the relative positional relationship between the training key and the training value and the relative positional relationship between the estimation key and the estimation value is similar, the type of the estimation document ED and the type of the training document may be different.

The value extraction model M in Modification Example 3 has learned a relative positional relationship between the training key and the training value which are included in a first type of the training document. In Modification Example 3, the first type of training document is an estimate. The training data shows the relative positional relationship between the training key and the training value included in a training image showing an estimate, which is a training document. The extraction module 105 extracts the estimation value from the estimation image EI, which shows a second type of estimation document ED different from the first type. In Modification Example 3, the second type of estimation document ED is a receipt. Modification Example 3 is different from the embodiment in that the types of the estimation document ED and the types of the training document are different from each other, but is similar to the embodiment in other respects.

The value extraction system 1 of Modification Example 3 extracts the estimation value from the estimation image EI showing a second type of estimation document ED different from the first type, which is the type of training document learned by the value extraction model M. As a result, the value extraction system 1 can extract the estimation value from the estimation image EI even when the types of the estimation document ED and the types of the training document are different from each other, and thus the versatility of the value extraction model M can be enhanced.

### 6-4. Modification Example 4

For example, in the embodiment, a case in which one specified key is input to the value extraction model M is given as an example, but each of a plurality of specified keys may be input to the value extraction model M one after another. In Modification Example 4, a case in which a “Total” specified key is input to the value extraction model M in addition to the “Payment” specified key described in the embodiment is given as an example. The number of specified keys is not limited to two, and may be three or more.

The value extraction model M in Modification Example 4 has learned a relative positional relationship between each of a plurality of the training keys and the training value corresponding to each of the plurality of training keys. The estimation document ED includes each of a plurality of estimation keys and an estimation value corresponding to each of the plurality of estimation keys. Those points are as described in the embodiment. The specified key acquisition module 104 in Modification Example 4 acquires a plurality of specified keys. For example, the user specifies a plurality of specified keys. The specified key acquisition module 104 acquires the plurality of specified keys from the user terminal 20. The plurality of specified keys may be determined in advance instead of being specified by the user.

The extraction module 105 in Modification Example 4 extracts the estimation value corresponding to each of the plurality of estimation keys from the estimation image EI based on each of the plurality of specified keys. For example, the extraction module 105 executes extraction of the estimation value described in the embodiment for each specified key. The extraction module 105 inputs each of the plurality of specified keys to the trained value extraction model M one after another. The extraction module 105 acquires estimation values successively output from the value extraction model M.

The extraction module 105 may input the plurality of specified keys to the value extraction model M all at once instead of inputting each of the plurality of specified keys to the value extraction model M separately. In this case, the value extraction model M has learned the relative positional relationships between the plurality of training keys and the training value corresponding to each of the plurality of training keys. The value extraction model M converts the plurality of specified keys into a feature amount, and outputs an estimation result corresponding to the feature amount.

The value extraction system 1 of Modification Example 4 extracts the estimation value corresponding to each of the plurality of estimation keys from the estimation image EI based on each of the plurality of specified keys. As a result, the estimation value corresponding to each of the plurality of specified keys can be extracted from one estimation image EI, and thus it is not required to prepare a separate value extraction model M for each specified key. Even when one estimation image EI includes estimation values corresponding to each of a plurality of specified keys, those estimation values can be handled by one value extraction model M.

### 6-5. Modification Example 5

For example, in the embodiment, a case in which the estimation value estimated by the value extraction model M is transmitted to the user terminal 20 is given as an example, but the estimation value estimated by the value extraction model M may be used for another purpose. In Modification Example 5, a case in which the estimation value estimated by the value extraction model M is used in additional learning by the value extraction model M is given as an example.

The value extraction system 1 of Modification Example 5 includes the additional generation module 106 and the additional learning module 107. The additional generation module 106 generates additional training data for the value extraction model M to learn based on the estimation image EI, the specified key, and the estimation value. For example, the additional generation module 106 generates the input portion of the additional training data based on the estimation key cell information on the estimation key cell extracted from the estimation image EI. The additional generation module 106 generates the output portion of the additional training data based on the estimation value cell information on the estimation value cell which includes the estimation value. The additional generation module 106 generates additional training data which includes the generated input portion and the generated output portion.

The additional learning module 107 executes additional learning by the value extraction model M based on the additional training data. The additional learning is learning based on additional training data. The additional learning itself may be similar to normal learning. For example, the additional learning module 107 executes the additional learning by the value extraction model M such that when the input portion of the additional training data is input to the value extraction model M, the output portion of the additional training data is output. The value extraction system 1 of Modification Example 5 generates additional training data for the value extraction model M to learn based on the estimation image EI, the specified key, and the estimation value. The value extraction system 1 executes additional learning by the value extraction model M based on the additional training data. As a result, the value extraction system 1 can improve the accuracy of the value extraction model M.

### 6-6. Modification Example 6

For example, there are cases in which the relative positional relationship between the estimation key and the estimation value is different depending on the language of the estimation document ED. For example, when the estimation document ED is in Arabic, the estimation value may be present to the left of the estimation key. For this reason, the value extraction model M may learn the relative positional relationship between the training key and the training value included in training documents of each of plurality of languages. The input portion of the training data in Modification Example 6 includes training language information relating to the language of the training document. Other portions of the training data may be the same as in the embodiment. For example, the training language information is an ID indicating a language such as English, Japanese, Korean, Chinese, or Arabic.

For example, the training data generation module 101 automatically identifies the language of the training document based on character recognition on the training document. The training data generation module 101 may identify the language of the training document based on a method other than character recognition (for example, a method using N-gram or a machine learning method). The creator of the value extraction model M may specify the language of the training document. The training data generation module 101 generates the training language information based on a result of identifying the language of the training document, and includes the generated training language information in the input portion of the training data. The method of generating the other portions of the training data may be the same as in the embodiment. The learning executed by the learning module 102 may also be the same as in the embodiment. The input portion of the training data includes the language identification information, and thus the value extraction model M learns the tendency of the relative positional relationship between the training key and the training value for each language.

The value extraction system 1 of Modification Example 6 includes the language identification module 108. The language identification module 108 identifies the language of the estimation document ED. For example, in the same manner as the training data generation module 101, the language identification module 108 may identify the language of the estimation document ED based on character recognition or another method. The user may specify the language of the estimation document ED. The language identification module 108 may identify the language of the estimation document ED by acquiring estimated language information relating to the language specified by the user from the user terminal 20.

The extraction module 105 in Modification Example 6 extracts the estimation value further based on the language of the estimation document ED. For example, the extraction module 105 inputs the estimated language information, the estimation cell information, and the specified key to the value extraction model M. The value extraction model M calculates a feature amount of the estimated language information, the estimation cell information, and the specified key, and outputs the estimation result corresponding to the feature amount. The extraction module 105 extracts the estimation value from the estimation image EI based on the estimation result output from the value extraction model M.

The value extraction system 1 of Modification Example 6 extracts the estimation value further based on the language of the estimation document ED. As a result, it is possible to perform the estimation corresponding to the language of the estimation document ED, thereby increasing the extraction accuracy of the estimation value.

### 6-7. Modification Example 7

For example, there are cases in which the relative positional relationship between the estimation key and the estimation value is different depending on a feature of an overall layout of the estimation document ED. Taking an estimation document ED written in Japanese as an example, the document may be a vertically written estimation document ED or a horizontally written estimation document ED. In addition, for example, there are estimation documents ED printed in the vertical direction and estimation documents ED printed in the horizontal direction. The same applies to other layouts, and the relative positional relationship between the estimation key and the estimation value may differ depending on the overall layout of the estimation document ED.

Thus, the value extraction model M may learn a feature relating to the overall layout of the training document. The input portion of the training data in Modification Example 7 includes training feature information relating to the feature of the overall layout of the training document. Other portions of the training data may be the same as in the embodiment. For example, the training feature information is an orientation of the character string such as vertical writing or horizontal writing, a print orientation such as vertical or horizontal, a font size, a margin size, a line spacing size, the number of characters per line, or the number of lines per page.

For example, the training data generation module 101 automatically identifies the feature of the overall layout of the training document based on character recognition on the training document. The training data generation module 101 may identify the feature of the overall layout of the training document based on a method other than character recognition (for example, a region extraction method, a line segment detection method, a template matching method, or a machine learning method). The creator of the value extraction model M may specify the feature of the overall layout of the training document.

The training data generation module 101 generates the training feature information based on a result of identifying the feature of the overall layout of the training document, and includes the generated training feature information in the input portion of the training data. The method of generating the other portions of the training data may be the same as in the embodiment. The learning executed by the learning module 102 may also be the same as in the embodiment. The input portion of the training data includes the feature identification information, and thus the value extraction model M learns the tendency of the relative positional relationship between the training key and the training value for each feature of the overall layout.

The value extraction system includes the feature identification module 109. The feature identification module 109 identifies the feature relating to the overall layout of the estimation image EI. For example, in the same manner as the training data generation module 101, the feature identification module 109 identifies the feature of the overall layout of the estimation document ED based on character recognition or another method. The user may specify the language of the estimation document ED. The feature identification module 109 may identify the feature of the overall layout of the estimation document ED by acquiring estimated feature information relating to the feature of the overall layout specified by the user from the user terminal 20.

The extraction module 105 in Modification Example 7 extracts the estimation value further based on the feature relating to the overall layout of the estimation image EI. For example, the extraction module 105 inputs the estimated feature information, the estimation cell information, and the specified key to the value extraction model M. The value extraction model M calculates a feature amount of the estimated feature information, the estimation cell information, and the specified key, and outputs the estimation result corresponding to the feature amount. The extraction module 105 extracts the estimation value from the estimation image EI based on the estimation result output from the value extraction model M.

The value extraction system 1 of Modification Example 7 extracts the estimation value further based on the feature relating to the overall layout of the estimation image EI. As a result, it is possible to perform the estimation corresponding to the overall layout of the estimation document ED, thereby increasing the extraction accuracy of the estimation value.

### 6-8. Modification Example 8

For example, in the embodiment, description has been given of a case in which the training key and the training value have a one-to-one relationship, but the training key and the training value may have a one-to-many relationship. The value extraction model M in Modification Example 8 has learned a relative positional relationship between one training key and each of a plurality of training values corresponding to the one training key. The output portion of the training data in Modification Example 8 includes training value cell information on each of the plurality f training values. Modification Example 8 is different from the embodiment in that training value cell information on each of a plurality of training values exists for one training key, but is the same as the embodiment in other respects.

The extraction module 105 in Modification Example 8 extracts a plurality of estimation values corresponding to one specified key from the estimation image EI. The input data that the extraction module 105 inputs to the trained value extraction model M is the same as in the embodiment. The value extraction model M calculates a feature amount of the input data, and outputs an estimation result corresponding to the feature amount. The value extraction model M may output only one estimation key or a plurality of estimation keys as the estimation result. When a plurality of estimation keys are output from the value extraction model M, the extraction module 105 extracts a plurality of estimation keys from the estimation image EI.

The value extraction system 1 of Modification Example 8 extracts a plurality of estimation values corresponding to one specified key from the estimation image EI. As a result, the value extraction system 1 can extract the plurality of estimation values from an estimation document ED in which the estimation key and the estimation value have a one-to-many correspondence.

### 6-9. Modification Example 9

For example, in Modification Example 8, the value extraction model M may learn a relative positional relationship between one training key and each of a plurality of training values arranged in a predetermined direction with respect to each other. The predetermined direction is any one of an upward direction, a downward direction, a direction to the right, or a direction to the left. In Modification Example 9, the plurality of training values are arranged below the training key. The learning method of the value extraction model M performed when a plurality of training values exist for one training key may be the same as in Modification Example 8.

For example, in the examples of the estimation image EI of FIG. 2 to FIG. 4, when the user makes a payment by using a combination of a plurality of payment methods, a character string indicating the first payment method is printed as a first estimation value to the right of the estimation key “Payment,” and below that, a character string(s) indicating the second and subsequent payment methods is/are printed as second and subsequent estimation values. In this way, a plurality of estimation values may be printed arranged in a certain predetermined direction. The plurality of estimation values may be arranged in a direction to the right or in an upward direction instead of in the downward direction.

The extraction module 105 in Modification Example 9 extracts, from the estimation image EI, each of the plurality of estimation values corresponding to one specified key and arranged in a direction with respect to each other. The processing of the extraction module 105 may be the same as in Modification Example 8. The value extraction model M has learned the relative positional relationship between the training key and a plurality of training values arranged in a predetermined direction, and thus the value extraction model M outputs each of the plurality of estimation values arranged in a predetermined direction as the estimation result. The extraction module 105 extracts, from the estimation image EI, each of the plurality of estimation values output from the value extraction model M and arranged in a predetermined direction.

The value extraction system 1 of Modification Example 9 extracts, from the estimation image EI, each of a plurality of estimation values corresponding to one specified key and arranged in a direction with respect to each other. As a result, the value extraction system 1 can extract a plurality of estimation values from an estimation document ED in which the estimation key and the estimation value have a one-to-many correspondence and a plurality of estimation values are arranged in a predetermined direction.

### 6-10. Modification Example 10

For example, in Modification Example 9, the extraction module 105 may determine, based on the estimation image EI, a search range to be searched by the value extraction model M in the predetermined direction, and extract each of the plurality of estimation values based on the search range. The search range is a range from which the estimation values are extracted from the estimation image EI. The extraction module 105 extracts the estimation values from the search range of the estimation image EI. For example, the extraction module 105 inputs estimation cell information on the estimation cells in the search range to the value extraction model M. The extraction module 105 does not input estimation cell information on estimation cells outside the search range to the value extraction model M.

The extraction module 105 may determine the search range based on a determination method determined in advance. For example, the extraction module 105 may determine the search range based on a size of the estimation document ED shown in the estimation image EI. In this case, the extraction module 105 determines the search range such that when the size of the estimation document ED becomes larger, the search range becomes wider. The extraction module 105 determines the search range based on the specified key. In this case, a relationship between the specified key and the search range is stored in the data storage unit 100 in advance. The extraction module 105 determines the search range by acquiring the search range associated with the specified key.

For example, when a predetermined image (for example, a line or a mark) is placed after the last estimation key arranged in a predetermined direction, the extraction module 105 may determine the search range based on the image. The extraction module 105 may identify the image from among the estimation images EI based on a method such as pattern matching, and determine the position to the image as the search range. The extraction module 105 may also determine, as the search range, an area in the estimation image EI which is within a predetermined distance from the position at which the same character string as the specified key is arranged. Modification Example 10 is different from the embodiment in that the value extraction model M sets the search range as the estimation target, but the estimation itself performed by the value extraction model M is as described in the embodiment.

The value extraction system 1 of Modification Example 10 determines a search range to be searched by the value extraction model M in a predetermined direction based on the estimation image EI, and extracts each of a plurality of estimation values based on the search range. As a result, the extraction accuracy of estimation values given when a plurality of estimation values are arranged in a predetermined direction increases.

### 6-11. Modification Example 11

For example, the value extraction system 1 may learn to extract an estimation value based not only on a positional relationship but also on character type (for example, characters (letters), numbers, a mixture of characters (letters) and numbers, and the like). For example, the character type of the training value may be included in the output portion of the training data.

For example, the training data generation module 101 automatically identifies the character type of the training value based on character recognition on the training document. The training data generation module 101 may identify the character type of the training value based on a method other than character recognition (for example, a method using N-gram or a machine learning method). The creator of the value extraction model M may specify the character type of the training value.

For example, the training data generation module 101 generates the training language information based on a result of identifying the character type of the training value, and includes the generated training language information in the output portion of the training data. The method of generating the other portions of the training data may be the same as in the embodiment. The learning executed by the learning module 102 may also be the same as in the embodiment. The output portion of the training data includes information on the character type of the training value, and thus the value extraction model M also learns the tendency of the character type of the training value corresponding to the training key.

### 6-12. Other Modification Examples

For example, the modification examples described above may be combined with one another.

For example, in the embodiment, a case in which the value extraction model M learns a relative positional relationship between a matrix of the training key and a matrix of the training value is given as an example, but the value extraction model M may learn a relative positional relationship between coordinates indicating the position of the training key and coordinates indicating the position of the training value. In this case, the estimation cell information includes the coordinates of the estimation cell EC. When the extraction module 105 inputs the estimation cell information and the specified key to the trained value extraction model M, the value extraction model M converts the coordinates of the estimation cell EC and the specified key into a feature amount, and outputs an estimation value corresponding to the feature amount. For example, the value extraction model M may learn the position of the character string without particularly extracting the estimation cell EC.

For example, in the embodiment, description has been given of a case in which the main processing is executed by the server 10, but the processing described as being executed by the server 10 may be executed by the user terminal 20 or another computer, or may be distributed to a plurality of computers.

### 7. Supplementary Notes

For example, the value extraction system may have the following configurations.
(1)

A value extraction system, including:
an estimation image acquisition module configured to acquire an estimation image showing an estimation document which includes an estimation key and an estimation value;
a specified key acquisition module configured to acquire a specified key specified by a user; and
an extraction module configured to extract the estimation value from the estimation image based on the estimation image, the specified key, and a value extraction model which has learned a relative positional relationship between a training key and a training value included in a training document shown in a training image.
(2)

The value extraction system according to Item (1),
wherein the value extraction model has learned a relative positional relationship between a row and a column of the training key in the training image and a row and a column of the training value in the training image, and
wherein the extraction module is configured to:
   acquire a row and a column of the specified key based on an execution result of character recognition on the estimation image; and
   extract the estimation value based on the row and the column of the specified key and the value extraction model.
(3)

The value extraction system according to Item (1) or (2),
wherein the value extraction model has learned a relative positional relationship between training key cell information relating to a position of a training key cell which includes the training key and training value cell information relating to a position of a training value cell which includes the training value, and
wherein the extraction module is configured to:
   acquire estimation key cell information relating to a position of an estimation key cell which includes the estimation key based on character recognition on the estimation image; and
   extract the estimation value based on the estimation key cell information and the value extraction model.
(4)

The value extraction system according to any one of Items (1) to (3),
wherein the value extraction model has learned whether the training value exists in each of a plurality of directions based on a position of the training key in the training image, and
wherein the extraction module is configured to extract the estimation value by causing the value extraction model to determine whether the estimation value exists in each of the plurality of directions based on a position of the specified key in the estimation image.
(5)

The value extraction system according to Item (4),
wherein a priority order is determined for each of the plurality of directions, and
wherein the extraction module is configured to extract, when a plurality of directions in which it is determined that the estimation value exists exist, the estimation value based on the priority order of each of the plurality of directions.
(6)

The value extraction system according to any one of Items (1) to (5),
wherein the value extraction model has learned a relative positional relationship between the training key and the training value which are included in a first type of the training document, and
wherein the extraction module is configured to extract the estimation value from the estimation image showing a second type of the estimation document different from the first type.
(7)

The value extraction system according to any one of Items (1) to (6),
wherein the value extraction model has learned a relative positional relationship between each of a plurality of the training keys and the training value corresponding to the each of the plurality of the training keys,
wherein the estimation document includes each of a plurality of the estimation keys and the estimation value corresponding to the each of the plurality of the estimation keys,
wherein the specified key acquisition module is configured to acquire a plurality of the specified keys, and
wherein the extraction module is configured to extract the estimation value corresponding to each of the plurality of the estimation keys from the estimation image based on each of the plurality of the specified keys.
(8)

The value extraction system according to any one of Items (1) to (7), further including:
a training data generation module configured to generate, based on character recognition on the training image, training data including training t key cell information relating to a position of a training key cell which includes the training key and training value cell information relating to a position of a training value cell which includes the training value; and
a learning module configured to execute learning by the value extraction model based on the training data,
wherein the extraction module is configured to extract the estimation value based on the value extraction model trained by the learning module.
(9)

The value extraction system according to any one of Items (1) to (8), further comprising:
an additional generation module configured to generate additional training data for the value extraction model to learn based on the estimation image, the specified key, and the estimation value; and
an additional learning module configured to execute additional learning by the value extraction model based on the additional training data.
(10)

The value extraction system according to any one of Items (1) to (9),
wherein the value extraction model has learned the relative positional relationship between the training key and the training value which are included in the training document of each of a plurality of languages,
wherein the value extraction system further includes a language identification module configured to identify a language of the estimation document, and
wherein the extraction module is configured to extract the estimation value further based on the language of the estimation document.
(11)

The value extraction system according to any one of Items (1) to (10),
wherein the value extraction model has learned a feature relating to an overall layout of the training document,
wherein the value extraction system further includes a feature identification module configured to identify a feature relating to an overall layout of the estimation image, and
wherein the extraction module is configured to extract the estimation value further based on the feature relating to the overall layout of the estimation image.
(12)

The value extraction system according to any one of Items (1) to (11),
wherein the value extraction model has learned a relative positional relationship between one training key and one training value corresponding to the one training key, and
wherein the extraction module is configured to extract one estimation value corresponding to one specified key from the estimation image.
(13)

The value extraction system according to any one of Items (1) to (12),
wherein the value extraction model has learned a relative positional relationship between one training key and each of a plurality of training values corresponding to the one training key, and
wherein the extraction module is configured to extract a plurality of estimation values corresponding to one specified key from the estimation image.
(14)

The value extraction system according to Item (13),
wherein the value extraction model has learned the relative positional relationship between the one training key and each of the plurality of training values arranged in a predetermined direction with respect to each other, and
wherein the extraction module is configured to extract, from the estimation image, each of the plurality of estimation values which correspond to the one specified key and which are arranged in the predetermined direction with respect to each other.
(15)

The value extraction system according to Item (14), wherein the extraction module is configured to determine, based on the estimation image, a search range to be searched by the value extraction model in the predetermined direction, and to extract each of the plurality of estimation values based on the search range.

The invention claimed is:

1: A value extraction system, comprising at least one processor configured to:
acquire an estimation image showing an estimation document which includes an estimation key and an estimation value;
acquire a specified key specified by a user; and
extract the estimation value from the estimation image based on the estimation image, the specified key, and a value extraction model which has learned a relative positional relationship between a training key and a training value included in a training document shown in a training image.

2: The value extraction system according to claim 1,
wherein the value extraction model has learned a relative positional relationship between a row and a column of the training key in the training image and a row and a column of the training value in the training image, and
wherein the at least one processor is configured to:
acquire a row and a column of the specified key based on an execution result of character recognition on the estimation image; and
extract the estimation value based on the row and the column of the specified key and the value extraction model.

3: The value extraction system according to claim 1,
wherein the value extraction model has learned a relative positional relationship between training key cell information relating to a position of a training key cell which includes the training key and training value cell information relating to a position of a training value cell which includes the training value, and
wherein the at least one processor is configured to:
acquire estimation key cell information relating to a position of an estimation key cell which includes the estimation key based on character recognition on the estimation image; and
extract the estimation value based on the estimation key cell information and the value extraction model.

4. The value extraction system according to claim 1,
wherein the value extraction model has learned whether the training value exists in each of a plurality of directions based on a position of the training key in the training image, and
wherein the at least one processor is configured to extract the estimation value by causing the value extraction model to determine whether the estimation value exists in each of the plurality of directions based on a position of the specified key in the estimation image.

5: The value extraction system according to claim 4,
wherein a priority order is determined for each of the plurality of directions, and
wherein the at least one processor is configured to extract, when a plurality of directions in which it is determined that the estimation value exists are present, the estimation value based on the priority order of each of the plurality of directions.

6: The value extraction system according to claim 1,
wherein the value extraction model has learned a relative positional relationship between the training key and the training value which are included in a first type of the training document, and
wherein the at least one processor is configured to extract the estimation value from the estimation image showing a second type of the estimation document different from the first type.

7: The value extraction system according to claim 1,
wherein the value extraction model has learned a relative positional relationship between each of a plurality of the training keys and the training value corresponding to the each of the plurality of the training keys,
wherein the estimation document includes each of a plurality of the estimation keys and the estimation value corresponding to the each of the plurality of the estimation keys,
wherein the at least one processor is configured to acquire a plurality of the specified keys, and
wherein the at least one processor is configured to extract the estimation value corresponding to each of the plurality of the estimation keys from the estimation image based on each of the plurality of the specified keys.

8: The value extraction system according to claim 1, wherein the at least one processor is configured to:
generate, based on character recognition on the training image, training data including training key cell information relating to a position of a training key cell which includes the training key and training value cell information relating to a position of a training value cell which includes the training value;
execute learning by the value extraction model based on the training data, and
extract the estimation value based on the trained value extraction model.

9: The value extraction system according to claim 1, wherein the at least one processor is configured to:
generate additional training data for the value extraction model to learn based on the estimation image, the specified key, and the estimation value; and
execute additional learning by the value extraction model based on the additional training data.

10: The value extraction system according to claim 1,
wherein the value extraction model has learned the relative positional relationship between the training key and the training value which are included in the training document of each of a plurality of languages,
wherein the at least one processor is configured to:
identify a language of the estimation document, and
extract the estimation value further based on the language of the estimation document.

11: The value extraction system according to claim 1,
wherein the value extraction model has learned a feature relating to an overall layout of the training document,
wherein the at least one processor is configured to:
identify a feature relating to an overall layout of the estimation image, and
extract the estimation value further based on the feature relating to the overall layout of the estimation image.

12: The value extraction system according to claim 1,
wherein the value extraction model has learned a relative positional relationship between one training key and one training value corresponding to the one training key, and
wherein the at least one processor is configured to extract one estimation value corresponding to one specified key from the estimation image.

13: The value extraction system according to claim 1,
wherein the value extraction model has learned a relative positional relationship between one training key and each of a plurality of training values corresponding to the one training key, and
wherein the at least one processor is configured to extract a plurality of estimation values corresponding to one specified key from the estimation image.

14: The value extraction system according to claim 13,
wherein the value extraction model has learned the relative positional relationship between the one training key and each of the plurality of training values arranged in a predetermined direction with respect to each other, and
wherein the at least one processor is configured to extract, from the estimation image, each of the plurality of estimation values which correspond to the one specified key and which are arranged in the predetermined direction with respect to each other.

15: The value extraction system according to claim 14, wherein at least one processor is configured to determine, based on the estimation image, a search range to be searched by the value extraction model in the predetermined direction, and to extract each of the plurality of estimation values based on the search range.

16: A value extraction method to be executed by a computer, the value extraction method comprising:
acquiring an estimation image showing an estimation document which includes an estimation key and an estimation value;
acquiring a specified key specified by a user; and
extracting the estimation value from the estimation image based on the estimation image, the specified key, and a value extraction model which has learned a relative positional relationship between a training key and a training value included in a training document shown in a training image.

17: A non-transitory computer-readable information storage medium for storing a program for causing a computer to:
acquire an estimation image showing an estimation document which includes an estimation key and an estimation value;
acquire a specified key specified by a user; and
extract the estimation value from the estimation image based on the estimation image, the specified key, and a value extraction model which has learned a relative positional relationship between a training key and a training value included in a training document shown in a training image.
